(19) United States
(12) Patent Application Publication
(10) Pub. No.: US 2014/0071655 A1
(43) Pub. Date: Mar. 13, 2014

(54) Direct Backlight Module

(71) Applicant: Yewen Wang, Shenzhen (CN)

(72) Inventor: Yewen Wang, Shenzhen (CN)

(73) Assignee: Shenzhen China Star Optoelectronics Technology Co., Ltd., Shenzhen City, Guangdong (CN)

(21) Appl. No.: 13/703,877

(22) PCT Filed: Sep. 21, 2012
(86) PCT No.: PCT/CN2012/081708

§ 371 Date: Dec. 12, 2012

(30) Foreign Application Priority Data
Sep. 11, 2012 (CN) 201210334462.8

(51) Int. Cl. F21K 99/00

(52) U.S. Cl. CPC F21K 9/56
USPC 362/84

(57) ABSTRACT

The present invention provides a direct backlight module, which includes a backplane, a backlight source arranged inside the backplane, and a diffuser plate mounted to the backplane and located above the backlight source. The backlight source includes a plurality of LED light bars. Each of the LED light bars includes a plurality of LED lights. The diffuser plate has a light incident surface opposing the backlight source. A phosphor powder layer is coated on the light incident surface of the diffuser plate. The LED lights give off light that excites the phosphor powder layer to give off light. The light given off by the excitation of the phosphor powder layer is mixed with a part of the light emitting from the LED lights to form white light desired for the backlight source.

### BACKGROUND OF THE INVENTION

1. Field of the Invention

The present invention relates to the field of liquid crystal display, and in particular to a direct backlight module.

2. The Related Arts

Liquid crystal display (LCD) has a variety of advantages, such as thin device body, low power consumption, and being free of radiation, and is thus widely used. Most of the LCDs that are currently available in the market are backlighting LCDs, which comprise a liquid crystal panel and a backlight module. The operation principle of the liquid crystal panel is that liquid crystal molecules are interposed between two parallel glass substrates and a plurality of vertical and horizontal fine electrical wires is arranged between the two glass substrates, whereby the liquid crystal molecules are controlled to change direction by application of electricity in order to refract light emitting from the backlight module for generating images. Since the liquid crystal panel itself does not emit light, light must be provided by the backlight module in order to normally display images. Thus, the backlight module is one of the key components of an LCD. The backlight module can be classified in two types, namely side-edge backlight module and direct backlight module, according to the position where light gets incident. The direct backlight module arranges a light source, such as a cold cathode fluorescent lamp (CCFL) or a light-emitting diode (LED), at the back side of the liquid crystal panel to form a planar light source that directly provides lighting to the liquid crystal panel.

Referring to FIG. 1, a conventional direct backlight module comprises: a backplane 100, LED light bars 200 arranged inside the backplane 100, a reflector plate 300 arranged inside the backplane 100, a diffuser plate 400 arranged above the reflector plate 300, an optic film assembly 500 arranged on the diffuser plate 400, and a mold frame 600 mounted to the backplane 100. The LED light bars 200 function as a light source giving off light that is mixed in a backlighting chamber 150 delimited by the backplane 100 and the diffuser plate 400 and is subsequently homogenized by the diffuser plate 400 and the optic film assembly 500, making the LED light bars 200 that are point light sources resembling a planar light source. Further, using LED light sources to replace CCFL light sources is more environmentally conservative and has better efficiency.

A conventional LED light is formed by packaging phosphor powders with a light-emitting chip. To cut down cost, the LED light sources adopted in the direct backlight module are often large power LED lights. However, if heat cannot be properly removed during operations, it easily occurs that the phosphor powders contained in the LED lights are susceptible to undesired influence and brightness deterioration and color shifting may result. To avoid generation of LED mura and to effect sufficient mixing of light, a light box of a great thickness is needed. This leads to an excessively large thickness of the backlight module and is opposite to the current trend of thinning.

### SUMMARY OF THE INVENTION

An object of the present invention is to provide a direct backlight module, which effectively overcomes the influence caused on phosphor powders by heat generated by light-emitting chip, saves energy, is favorable for environmental conservation, and facilitates homogeneous light emission from the phosphor powders to thereby improve homogeneity of color and brightness, reduce color shifting, and effectively alleviate the excessive LED light box thickness issue of direct backlight module to achieve the purpose of thinning.

To achieve the above object, the present invention provides a direct backlight module, which comprises a backplane, a backlight source arranged inside the backplane, and a diffuser plate mounted to the backplane and located above the backlight source. The backlight source comprises a plurality of LED light bars. Each of the LED light bars comprises a plurality of LED lights. The diffuser plate comprises a light incident surface opposing the backlight source. A phosphor powder layer is coated on the light incident surface of the diffuser plate. The LED lights give off light that excites the phosphor powder layer to give off light. The light given off by the excitation of the phosphor powder layer is mixed with a part of the light emitting from the LED lights to form white light desired for the backlight source.

The LED lights comprise blue LED lights.

The phosphor powder layer coated on the diffuser plate comprises yellow YAG phosphor powder layer.

The phosphor powder layer coated on the diffuser plate comprises a green phosphor powder layer and a red phosphor powder layer. The green phosphor powder layer is coated on the light incident surface of the diffuser plate. The red phosphor powder layer is coated on the green phosphor powder layer.

The backlight source further comprises a PCB arranged inside the backplane. The plurality of LED lights is mounted on and in electrical connection with the PCB.

The LED lights each comprise a frame, a light-emitting chip mounted inside the frame, and package resin that packages the light-emitting chip within the frame.

The package resin comprises epoxy resin.

The plurality of LED lights of each of the LED light bars is arranged to be uniformly spaced from each other.

The backplane comprises a bottom board and a side board connected to the bottom board. The LED light bars are mounted on the bottom board of the backplane.

The direct backlight module further comprises a reflector plate arranged between the bottom board of the backplane and the LED light bars and an optic film assembly arranged on the diffuser plate.

The present invention also provides a direct backlight module, which comprises a backplane, a backlight source arranged inside the backplane, and a diffuser plate mounted to the backplane and located above the backlight source, the backlight source comprising a plurality of LED light bars, each of the LED light bars comprising a plurality of LED lights, the diffuser plate comprising a light incident surface opposing the backlight source, a phosphor powder layer being coated on the light incident surface of the diffuser plate, the LED lights giving off light that excites the phosphor powder layer to give off light, the light given off by the excitation of the phosphor powder layer being mixed with a part of the light emitting from the LED lights to form white light desired for the backlight source;

wherein the LED lights comprise blue LED lights;

wherein the phosphor powder layer coated on the diffuser plate comprises yellow YAG phosphor powder layer;

wherein the backlight source further comprises a PCB arranged inside the backplane, the plurality of LED lights being mounted on and in electrical connection with the PCB;

wherein the LED lights each comprise a frame, a light-emitting chip mounted inside the frame, and package resin that packages the light-emitting chip within the frame;

wherein the package resin comprises epoxy resin;

wherein the plurality of LED lights of each of the LED light bars is arranged to be uniformly spaced from each other;

wherein the backplane comprises a bottom board and a side board connected to the bottom board, the LED light bars being mounted on the bottom board of the backplane; and

further comprising a reflector plate arranged between the bottom board of the backplane and the LED light bars and an optic film assembly arranged on the diffuser plate.

The efficacy of the present invention is that the present invention provides a direct backlight module, which provides an arrangement that the phosphor powders of the backlight source are spaced from the LED lights by coating the phosphor powder on a light incidence surface of the diffuser plate so as to effectively overcome the influence caused on the optical performance of the phosphor powder by the heat generated by the light-emitting chip to thereby save energy and facilitate environmental protection and also improve homogeneity of color and brightness, reduce color shifting, and effectively alleviate the excessive thickness of LED light box of thee direct backlight module thereby achieving the purpose of thinning.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, of the present invention will be apparent from the following detailed description of one or more embodiments of the present invention, with reference to the attached drawings. In the drawings:

FIG. 1 is a schematic view showing a conventional direct backlight module;

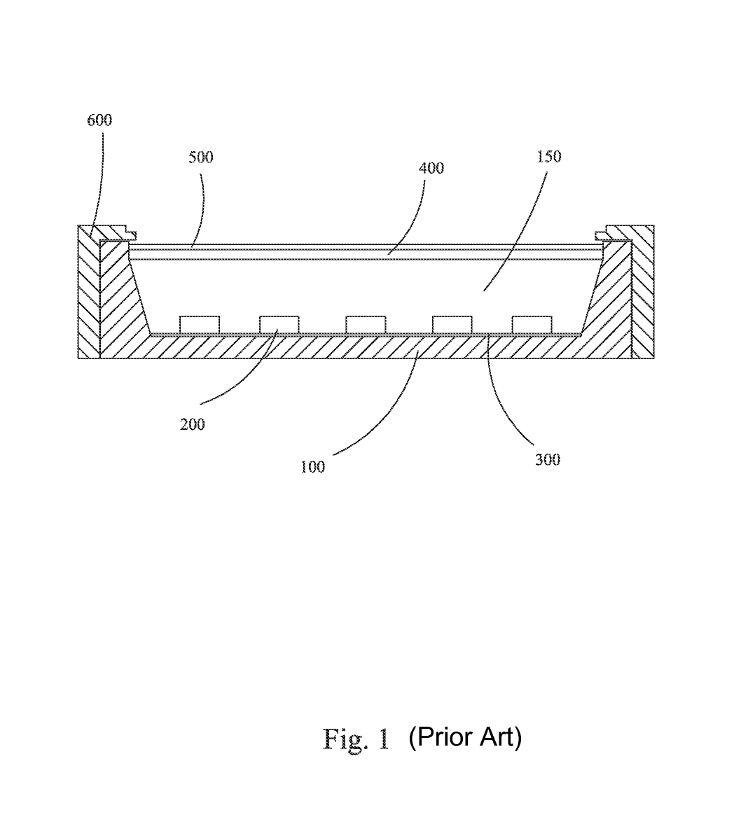

FIG. 2 is a schematic view showing a direct backlight module according to a preferred embodiment of the present invention; and

FIG. 3 is a schematic view showing a direct backlight module according to another preferred embodiment of the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

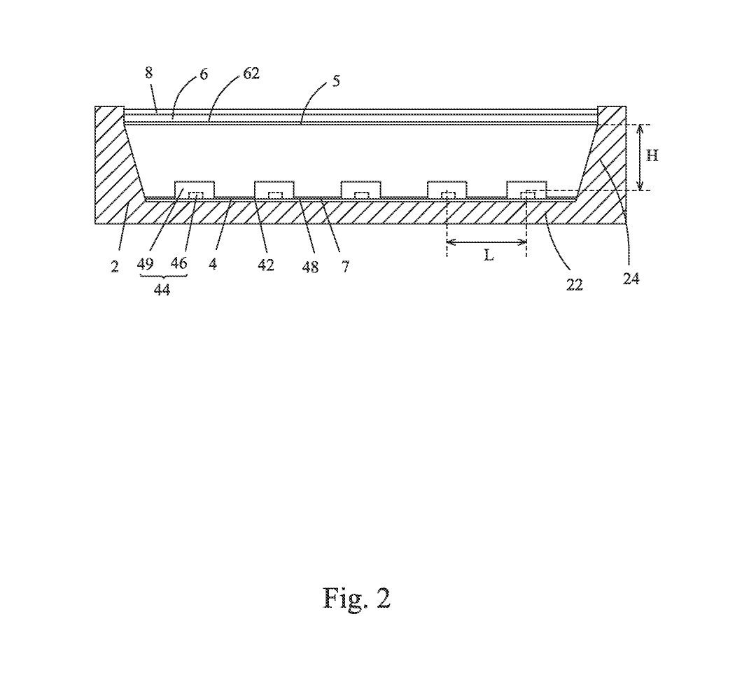

Referring to FIG. 2, the present invention provides a direct backlight module, which comprises a backplane 2, a backlight source 4 arranged inside the backplane 2, and a diffuser plate 6 mounted to the backplane 2 and located above the backlight source 4.

The backlight source 4 comprises a plurality of LED light bars 42. Each of the LED light bars 42 comprises a plurality of LED lights 44. Preferably, the plurality of LED lights 44 is arranged to be uniformly spaced from each other. Each of the LED lights 44 comprises a light-emitting chip 46. The diffuser plate 6 has a light incident surface 62 opposing the backlight source and a phosphor powder layer 5 is coated on the light incident surface 62 of the diffuser plate 6. The LED lights 44 gives off light that excites the phosphor powder layer 5 to give off light. The light given off by the excitation of the phosphor powder layer 5 is mixed with a part of the light emitting from the LED lights 44 to form white light desired for the backlight source 4. The present invention provides an arrangement that the phosphor powder layer 5 is separate from the light-emitting chip 46 and the phosphor powder layer 5 is arranged on the light incident surface 62 of the diffuser plate 6, thereby facilitating homogeneous light emission of the phosphor powder layer 5, reducing the thickness of LED light box of the direct backlight module, and also effectively alleviating the influence caused on the optical performance of phosphor powder by the heat generated by the light-emitting chip 46 so as to further save energy and facilitate environmental protection.

In the preferred embodiment, the LED lights 42 are blue LED lights, which each comprise a frame (not shown), a light-emitting chip 46 mounted inside the frame, and package resin 49 that packages the light-emitting chip 46 within the frame. The package resin 49 is epoxy resin. The light-emitting chip 46 is a blue light chip that, after excited, gives off blue light. The phosphor powder layer 5 coated on the diffuser plate 6 is a yellow YAG phosphor powder layer, which, when excited, gives off yellow light. The yellow light is mixed with a portion of the blue light emitting from the light-emitting chip 46 to form a white light desired by the backlight source 4.

The backlight source 4 further comprises a printed circuit board (PCB) 48 mounted inside the backplane 2. The plurality of LED lights 44 is mounted on and in electrical connection with the PCB 48. To enhance performance of heat conduction to quickly dissipate the heat generated by the light-emitting chip 46, the PCB 48 and the backplane 2 may comprise an aluminum extrusion (not shown) arranged therebetween.

The LED lights 44 are spaced from the phosphor powder layer 5 by a distance H and the spacing distance between two adjacent LED lights 44 of the LED light bars 42 is L, wherein H>0.3L.

The backplane 2 comprises a bottom board 22 and a side board 24 connected to the bottom board 22. The LED light bars 42 are mounted on the bottom board 22 of the backplane 2.

The direct backlight module further comprises a reflector plate 7 arranged between the bottom board 22 of the backplane 2 and the LED light bars 42 and an optic film assembly 8 arranged on the diffuser plate 6. The backlight source 4 gives off light that directly enters or is reflected by the reflector plate 7 to enter the phosphor powder layer 5 to effect light mixture for forming white light desired by the backlight source that then enters the diffuser plate 6 and eventually enters the optic film assembly 8 to provide a homogenous planar light source.

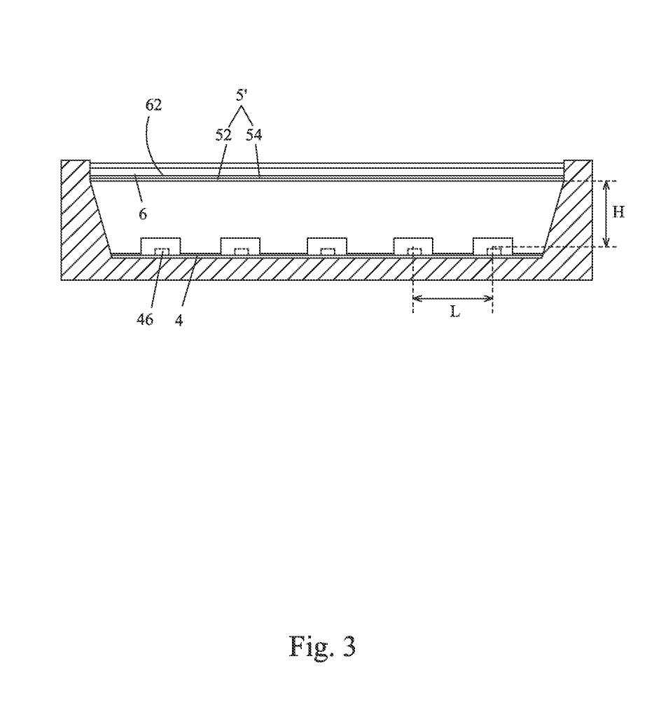

Referring to FIG. 3, another preferred embodiment that can be alternatively used is shown, in which the light-emitting chip 46 is a blue light chip, which when activated gives off blue light. The phosphor powder layer 5′ coated on the diffuser plate 6 comprises a green phosphor powder layer 54 and a red phosphor powder layer 52. The green phosphor powder layer 54 is coated on the light incident surface 62 of the diffuser plate 6. The red phosphor powder layer 52 is coated on the green phosphor powder layer 54. The green phosphor powder layer 54 and the red phosphor powder layer 52 may be excited by the blue light emitting from the light-emitting chip 46 to give off light that is mixed to form a reddish green light, which is further mixed with a portion of the blue light from the light-emitting chip 46 to form white light desired by the backlight source 4.

In summary, the present invention provides a direct backlight module, which provides an arrangement that the phosphor powders of the backlight source are spaced from the LED lights by coating the phosphor powder on a light incidence surface of the diffuser plate so as to effectively overcome the influence caused on the optical performance of the phosphor powder by the heat generated by the light-emitting chip to thereby save energy and facilitate environmental protection and also facilitate homogeneous lighting of the phosphor powder to improve homogeneity of color and brightness, reduce color shifting, and effectively alleviate the excessive thickness of LED light box of thee direct backlight module thereby achieving the purpose of thinning.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A direct backlight module, comprising a backplane, a backlight source arranged inside the backplane, and a diffuser plate mounted to the backplane and located above the backlight source, the backlight source comprising a plurality of LED light bars, each of the LED light bars comprising a plurality of LED lights, the diffuser plate comprising a light incident surface opposing the backlight source, a phosphor powder layer being coated on the light incident surface of the diffuser plate, the LED lights giving off light that excites the phosphor powder layer to give off light, the light given off by the excitation of the phosphor powder layer being mixed with a part of the light emitting from the LED lights to form white light desired for the backlight source.

2. The direct backlight module as claimed in claim 1, wherein the LED lights comprise blue LED lights.

3. The direct backlight module as claimed in claim 2, wherein the phosphor powder layer coated on the diffuser plate comprises yellow YAG phosphor powder layer.

4. The direct backlight module as claimed in claim 2, wherein the phosphor powder layer coated on the diffuser plate comprises a green phosphor powder layer and a red phosphor powder layer, the green phosphor powder layer being coated on the light incident surface of the diffuser plate, the red phosphor powder layer being coated on the green phosphor powder layer.

5. The direct backlight module as claimed in claim 1, wherein the backlight source further comprises a PCB arranged inside the backplane, the plurality of LED lights being mounted on and in electrical connection with the PCB.

6. The direct backlight module as claimed in claim 1, wherein the LED lights each comprise a frame, a light-emitting chip mounted inside the frame, and package resin that packages the light-emitting chip within the frame.

7. The direct backlight module as claimed in claim 6, wherein the package resin comprises epoxy resin.

8. The direct backlight module as claimed in claim 1, wherein the plurality of LED lights of each of the LED light bars is arranged to be uniformly spaced from each other.

9. The direct backlight module as claimed in claim 1, wherein the backplane comprises a bottom board and a side board connected to the bottom board, the LED light bars being mounted on the bottom board of the backplane.

10. The direct backlight module as claimed in claim 9 further comprising a reflector plate arranged between the bottom board of the backplane and the LED light bars and an optic film assembly arranged on the diffuser plate.

11. A direct backlight module, comprising a backplane, a backlight source arranged inside the backplane, and a diffuser plate mounted to the backplane and located above the backlight source, the backlight source comprising a plurality of LED light bars, each of the LED light bars comprising a plurality of LED lights, the diffuser plate comprising a light incident surface opposing the backlight source, a phosphor powder layer being coated on the light incident surface of the diffuser plate, the LED lights giving off light that excites the phosphor powder layer to give off light, the light given off by the excitation of the phosphor powder layer being mixed with a part of the light emitting from the LED lights to form white light desired for the backlight source;
wherein the LED lights comprise blue LED lights;
wherein the phosphor powder layer coated on the diffuser plate comprises yellow YAG phosphor powder layer;
wherein the backlight source further comprises a PCB arranged inside the backplane, the plurality of LED lights being mounted on and in electrical connection with the PCB;
wherein the LED lights each comprise a frame, a light-emitting chip mounted inside the frame, and package resin that packages the light-emitting chip within the frame;
wherein the package resin comprises epoxy resin;
wherein the plurality of LED lights of each of the LED light bars is arranged to be uniformly spaced from each other;
wherein the backplane comprises a bottom board and a side board connected to the bottom board, the LED light bars being mounted on the bottom board of the backplane; and
further comprising a reflector plate arranged between the bottom board of the backplane and the LED light bars and an optic film assembly arranged on the diffuser plate.
